(19) United States
(12) Patent Application Publication
(10) Pub. No.: US 2026/0175377 A1
(43) Pub. Date: Jun. 25, 2026

(54) ANTI-SLIP OPEN END WRENCH

(71) Applicant: Stanley Black & Decker MEA FZE, Dubai (AE)

(72) Inventor: Tai-Yi Teng, Taichung City (TW)

(21) Appl. No.: 19/000,988

(22) Filed: Dec. 24, 2024

(51) Int. Cl. B25B 23/10; B25B 13/50

(52) U.S. Cl. CPC B25B 23/10; B25B 13/5008

(57) ABSTRACT

Wrenches capable of gripping rounded fasteners, where the wrench has a handle portion and a containing portion, the containing portion having a first jaw and a second jaw. The first jaw and the second jaw together define a containing groove configured to receive a fastener, the containing groove ending at a curved edge. The first jaw has teeth extending into the containing groove, and the second jaw has a ridge extending into the containing groove.

### BACKGROUND

### 1. Technical Field

The present disclosure relates to wrenches, and more specifically to a wrench capable of gripping rounded fasteners.

### 2. Introduction

A wrench is a tool used to grip, tighten, loosen, or turn objects like nuts, bolts, and pipes. Wrenches have a handle attached to a containing portion, the containing portion having a first jaw and a second jaw, the jaws together defining a containing groove configured to receive fasteners or other workpieces. However, over time fasteners such as nuts and bolts can become rounded, limiting the ability to tighten or loosen such fasteners with a wrench.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are open-end wrenches which provide a technical solution to the technical problem described. An open-end wrench for performing the concepts disclosed herein can include: a handle portion; and a containing portion, the containing portion comprising: a first jaw and; a second jaw, wherein: the first jaw and the second jaw together define a containing groove configured to receive a fastener; the containing groove ends at a curved edge; the first jaw comprises a plurality of teeth extending into the containing groove; and the second jaw comprising a ridge extending into the containing groove

An open-end wrench for performing the concepts disclosed herein can include: a first jaw and; a second jaw, wherein: the first jaw and the second jaw together define a containing groove configured to receive a fastener; the containing groove ends at a curved edge; the first jaw comprises a plurality of teeth extending into the containing groove; and the second jaw comprising a ridge extending into the containing groove, wherein upon receiving a new hexagonal fastener into the containing groove, the new hexagonal fastener sized to engage with the open end-wrench, the ridge prevents the new hexagonal fastener from going further into the containing groove, and wherein upon receiving a rounded hexagonal fastener into the containing groove, the rounded hexagonal fastener sized to engage with the open end-wrench, applied torque allows the rounded hexagonal fastener to go further than the new hexagonal fastener into the containing groove, such that the rounded hexagonal fastener engages with the teeth and the ridge.

An open-end wrench for performing the concepts disclosed herein can include: a first jaw and; a second jaw, wherein: the first jaw and the second jaw together define a containing groove configured to receive a fastener; the first jaw comprises a plurality of teeth extending into the containing groove; and the second jaw comprising a ridge extending into the containing groove.

### BRIEF DESCRIPTION OF THE DRAWINGS

FIG. 1 illustrates an example wrench configured as disclosed herein with a hexagonal (hex) fastener;

FIG. 2 illustrates the example wrench of FIG. 1, with both a hex fastener and a rounded fastener;

FIG. 3 illustrates the example wrench of FIG. 1 with exemplary angles and distances;

FIG. 4A illustrates the example wrench of FIG. 1 receiving a rounded fastener;

FIG. 4B illustrates the example wrench of FIG. 1 engaging with the rounded fastener of FIG. 4A; and

FIG. 5 illustrates a close-up view of a ridge used to engage with a rounded fastener.

### DETAILED DESCRIPTION

Various embodiments of the disclosure are described in detail below. While specific implementations are described, this is done for illustration purposes only. Other components and configurations may be used without parting from the spirit and scope of the disclosure.

Wrenches configured as disclosed herein are open-ended wrenches that can provide hold hex bolts, nuts, or other fasteners (cumulatively referred to herein as “fasteners”) in place within the wrench while applying torque, while also providing additional protection those fasteners by limiting the amount of wear to those fasteners. This is accomplished via a ridge (aka a protrusion) extending from one jaw of the wrench into the wrench cavity. The ridge prevents a normal/non-damaged fastener from advancing, while allowing a damaged/rounded fastener to roll past the ridge. When the damaged/rounded fastener rolls past the ridge, the ridge presses the fastener toward the opposite jaw, where an angled series of teeth are provided. The rounded fastener is thus wedged between the ridge and the teeth. With the rounded bolt secured, a user can apply torque to the wrench, removing or tightening the rounded fastener as desired.

The teeth and the ridge are on opposite jaws of the wrench. If, for example, the wrench is positioned such that the upper jaw has the ridge, the lower jaw will have teeth. Prior to the ridge or the teeth, the respective jaws can be flat. For example, from the end of the wrench (i.e., the mouth) along the upper jaw, the upper jaw can be flat (i.e., a flat edge) until the ridge. Likewise, from the end of the wrench (i.e., the mouth) along the lower jaw, the lower jaw can be flat until the teeth. In other configurations, the jaws of the wrench prior to the ridge or teeth can have notches, curves, and/or bumps as desired so long as the notches, curves, and/or bumps allow for a normal/non-damaged fastener to fit squarely into the wrench (i.e., the portions of the jaws prior to the ridge and teeth should be sufficiently parallel to allow for a normal, unrounded fastener to be securely held in place between the upper/lower jaws).

The teeth should be set at an angle in the range of 3°-18° from the centerline between the upper and lower jaws. Preferably, the angle of the teeth is between 10° and 18° from the centerline. Notably, the entirety of the jaw containing the teeth does not need to be at this angle. That is, while the teeth are set at an angle, the flat edge of the jaw (extending from the mouth/end of the wrench) should be parallel to both the centerline and the flat edge of the other jaw.

The wrench contains a curved edge which extends to the ridge on one jaw and the teeth on the other jaw. The depth of the curved edge, measured from a line extending from the ridge to a perpendicular point on the teeth, must be equal to or greater than the radius of the corresponding fastener of the wrench. For example, if the wrench is meant for a 10 mm fastener, the curved edge should be a distance of 5 mm or more from the line extending from the ridge to a perpendicular point on the teeth. Preferably, the line extending from the ridge to the perpendicular point on the teeth passes through the center point of a rounded fastener when that rounded fastener is rolled past the ridge and becomes held securely in place between the ridge and the teeth.>

The height of the ridge can also vary depending on the size of the fastener for which the wrench is intended. In general, the ridge can have a height between 0.3-1.5 mm. Preferably, the ridge height is determined by the following equation:

$$Ridge Height = ( \frac{{D}_{2} - {D}_{1}}{2} ) \times 0.8 \qquad Equation ( 1 )$$

### Where:

D1=Diameter of a bolt from flat edge to flat edge; and
D2=Diameter of the bolt from corner to corner.

Preferably, the ridge has a sharp ascent side and a gradual ascent side. The sharp ascent side, which is proximate to the flat edge, rises quickly from the flat edge to the point of the ridge. The gradual ascent side, which is a continuation of the curved edge, reaches the point of the ridge at a less acute angle compared to the sharp ascent side.

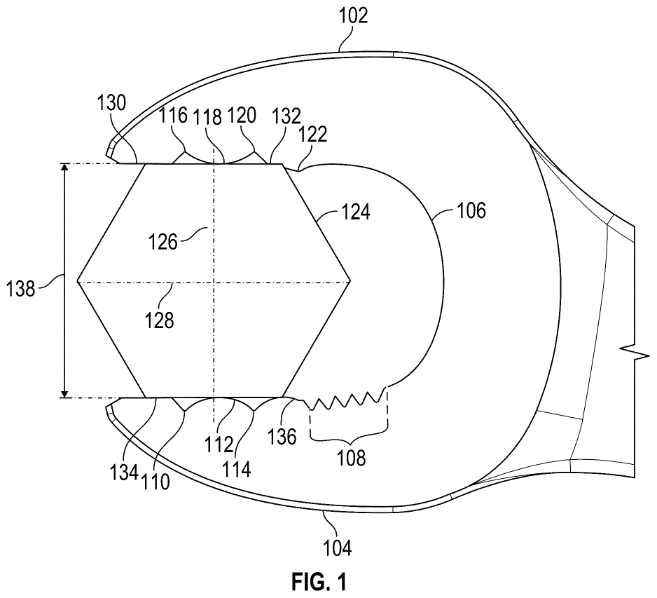

FIG. 1 illustrates an example wrench configured as disclosed herein with a hexagonal (hex) fastener 124. As illustrated, the wrench has an upper jaw 102 and a lower jaw 104, with the upper jaw 102 and the lower jaw 104 together forming a mouth 138 to receive the hex fastener 124 into a containing groove, the containing groove ending in a curved edge 106. In this example both the upper jaw 102 and lower jaw 104 have (progressing through the containing groove from the mouth 138 to the curved edge 106) a first flat edge 130, 134, followed by a notch 110, 116, a bump 112, 118, and another, second notch 114, 120. Following the second notch 120 on the upper jaw 102 (again moving from the mouth 138 to the curved edge 106), the upper jaw 102 then has a second flat edge 132 and a ridge 122. Following the second notch 114 on the lower jaw 104 (again moving from the mouth 138 to the curved edge 106), the lower jaw 104 has another second flat edge 136, followed by a series of teeth 108. The number of teeth 108 can vary as needed, and generally vary in number based on a proportional change with the size of the wrench. For example, for a 9/16″ (corresponding to 14.30 mm) wrench, the preferred number of teeth that can be placed is five, with the tooth profile similar to that in the jaws of a pipe wrench. The purpose of the teeth 108 includes using the friction of the teeth to minimize the rotation or slipping of roughly cylindrical objects or fasteners.

For both the upper jaw 102 and lower jaw 104, the second flat edge 132, 136 may be a bump, flat edge, or other shape as needed, the second flat edge 132, 136 not exceeding the height of the first flat edge 130, 134 or the height of the bump 112, 118. In some configurations, the first flat edge 130, 134 will continue until the ridge 122 or the teeth 108 (i.e., the bumps 112, 118 and notches 110, 114, 116, 120 will not be present, and the second flat edges 132, 136 will become part of the first flat edges 130, 134).

The hex fastener 124, as illustrated, can fit into the wrench's containing groove via the mouth 138, the fastener having an edge-to-edge width 126, and a corner-to-corner width 128. However, the hex fastener 124 stops at the ridge 122, and cannot (when properly touching both the upper jaw 102 and the lower jaw 104) contact the curved edge 106. The height of the ridge 122 from the first flat edges 130, 134 and from the second flat edges 132, 136 can be determined at least in part based on the size of the hex fastener 124 that the wrench is configured to receive.

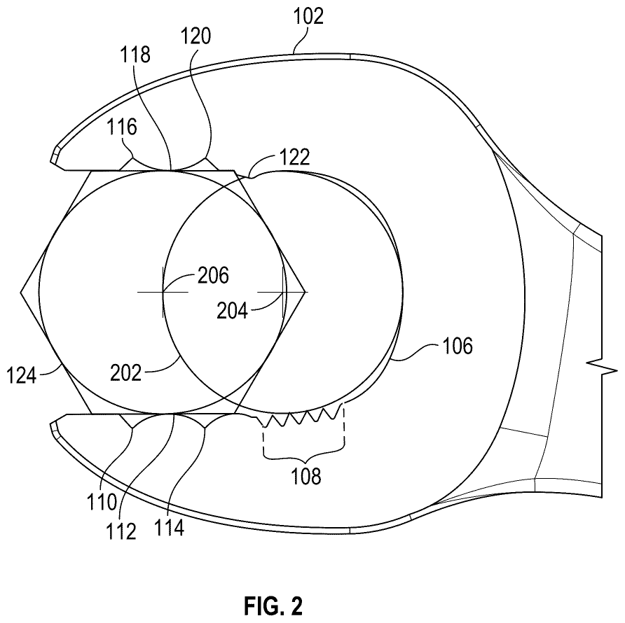

FIG. 2 illustrates the example wrench of FIG. 1, with both a hex fastener 124 and a rounded fastener 202. While in reality the wrench will not be able to accommodate both the hex fastener 124 and the rounded fastener 202, the purpose of the illustration is to show that the rounded fastener 202 can move further into the wrench than the hex fastener 124. As described in FIG. 1, the hex fastener 124 cannot advance through the containing groove past the ridge 122, with the center of the hex fastener (when stopped) located at center point 206. When the rounded fastener 202 is pushed to the ridge 122, applied torque can allow the rounded fastener 202 to move further into the containing groove of the wrench, allowing for contact with the curved edge 106, the teeth 108, and the ridge 122, such that the center of the rounded fastener (when pushed beyond the ridge 122 and in contact with the curved edge 106) is at point 204—the rounded fastener 202 center point 204 being significantly further into the containing groove of the wrench than the hex fastener 124 center point 206.

As illustrated, a hex fastener 124 will engage with the ridge 122 until the hex fastener 124 becomes a rounded fastener 202, at which point the rounded fastener 202 can roll/slide past the ridge 122. As an example, a hex fastener 124 will engage with the ridge 122 until it becomes 10% rounded, at which point the fastener (now a rounded fastener 202) will roll past the ridge 122. In other configurations, the ridge 122 may engage fasteners to distinct levels of wear/roundedness (e.g., 5% rounded, 15% rounded, etc.). A “10% rounded nut” refers to a hexagonal nut (or other fastener) where the corners of the hex are slightly rounded off, with the rounded edges making up approximately 10% of the total face width of the nut. In such an example the nut has a slightly “chamfered” edge, providing a smoother finish and potentially reducing stress points on the nut when tightened. Likewise, a “60% rounded nut” refers to a type of hexagonal nut (or other fastener) where the corners of the hexagonal flats are rounded off, with approximately 60% of the original flat surface remaining, creating a slightly curved edge instead of a sharp corner. Stated differently, the percentage of roundedness can be calculated as follows: Percentage rounded=1−((L−S)/(E−S)), where: S=the edge-to-edge width 126, E=the corner-to-corner width 128 of a new/fresh fastener, and L=the current corner-to-corner width of a fastener. Thus, if L=E, the nut is 0% rounded, whereas if L=S, the nut is 100% rounded. Preferably, wrenches configured as disclosed herein catch fasteners rounded up to 10% on the ridge 122, and fasteners rounded more than 10% roll beyond the ridge 122.

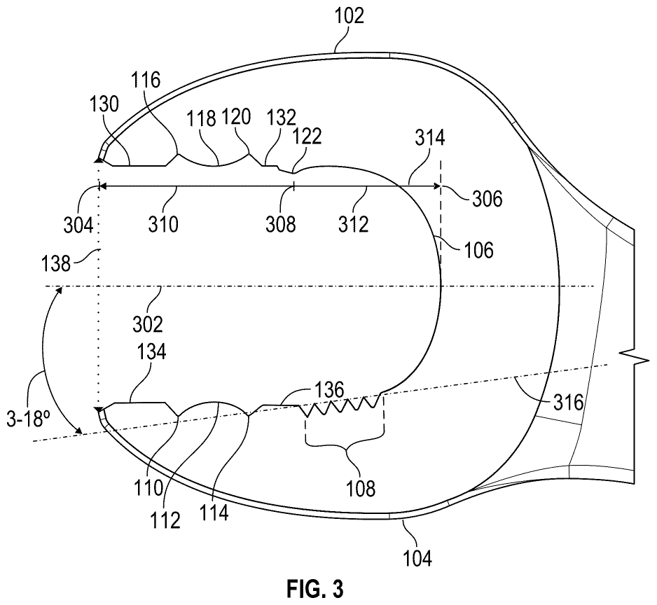

FIG. 3 illustrates the example wrench of FIG. 1 with exemplary angles and distances. Specifically, FIG. 3 illustrates a centerline 302 which is equidistant between the upper jaw 102 and the lower jaw 104, and represents the center point between the upper jaw 102 and lower jaw 104 through the mouth 138 of the wrench to the curved edge 106. The teeth 108 follow a line 316 set between 3° and 18° away from the centerline 302. Preferably, the line 316 is between 10° and 18°.

FIG. 3 also illustrates the distance of the ridge 122 from the beginning of the mouth 138, or likewise from the end of the curved edge 106. As illustrated in FIG. 3, there is a line 314 parallel to the first flat edge 130 of the upper jaw 102, the line 314 illustrating the depth of the containing groove from the opening 304 (i.e., the end of the wrench) to a point 306 equally distant from the opening 304 as the deepest point of the containing groove (i.e., the vertex of the curved edge 106). This line 314 is divided into two portions: a first portion 310 extending from the opening 304 to a ridge point 308 marking the location of the ridge 122, and a second portion 312 extending from the location of the ridge 122 to the point 306. Preferably, the ridge 122 is located 75% of the distance through the containing groove, such that the first portion 310 is three times the length of the second portion 312. In other configurations, the location of the ridge 122 may vary according to needs or variation. For example, changing the angle of the line 316 for the teeth 108 may change the location of the ridge 122 with respect to the mouth 138 and the curved edge 106.

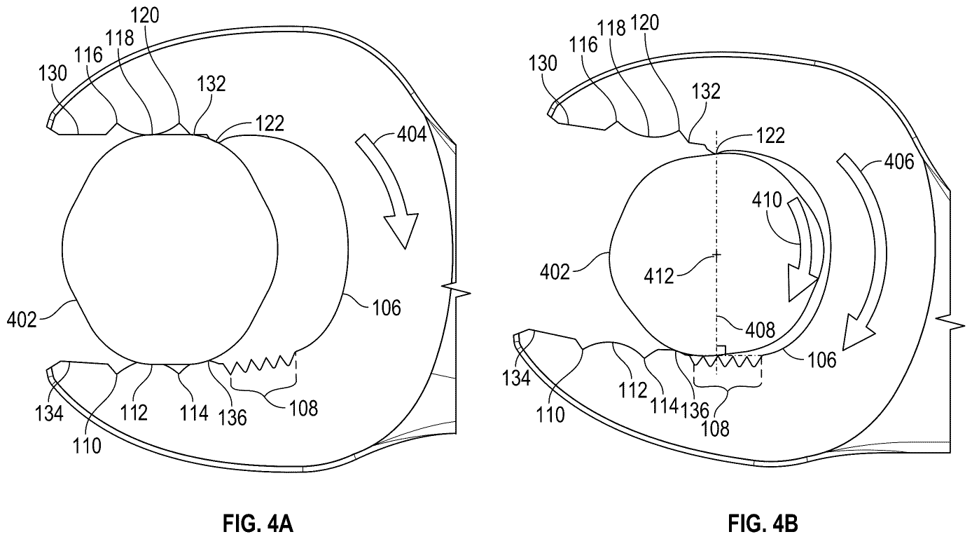

FIG. 4A illustrates the example wrench of FIG. 1 receiving a rounded fastener 402. As illustrated, the rounded fastener 402 is inserted into the wrench until engaging with the ridge 122. As the user applies torque 404, the rounded fastener 402 can roll further into the containing groove, engaging with the teeth 108 and the ridge 122. In some configurations, once rolled further into the wrench the rounded fastener 402 may also engage with the curved edge 106.

FIG. 4B illustrates the example wrench of FIG. 1 engaging with the rounded fastener of FIG. 4A. As illustrated, the rounded fastener 402 is now deeper in the containing groove, with contact points at the ridge 122 and the teeth 108. Preferably, the rounded fastener 402 is engaged with the ridge 122 and the teeth 108 such that the center 412 of the rounded fastener 402 is located on a line 408 extending from the ridge 122 to the teeth 108, where the line 408 is perpendicular to the angle of the teeth 108.

As the user applies additional torque 406 to the wrench, the contact of the wrench (via the ridge 122, the teeth 108, and/or other points of contact such as the curved edge 106) cause the rounded fastener 402 to rotate 410 (e.g., loosen or tighten) as desired.

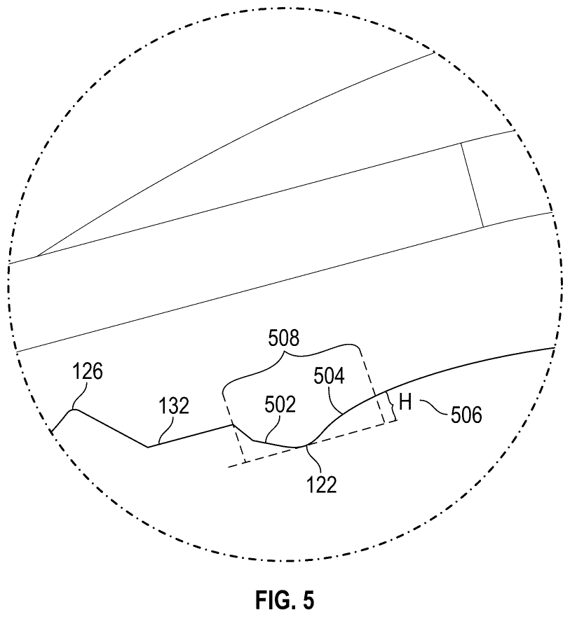

FIG. 5 illustrates a close-up view of a ridge 122 used to engage with a rounded fastener. As illustrated, the ridge is next to a flat edge 132 (referred to in FIG. 1 as a second flat edge 132 following a notch 120). The ridge 122 reaches a height H 506, and has a width 508. As described above using Equation 1, the height is determined at least in part using the size (i.e., flat and corner diameters) of the fastener for which the wrench is designed. The width 508 can depend on the angles of the edges/sides of the ridge 122. As illustrated, preferably the first edge 502 closer to the mouth 138 of the wrench has a sharper angle than the second edge 504 closer to curved edge 106 of the wrench.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

An open-end wrench, comprising: a handle portion; and a containing portion, the containing portion comprising: a first jaw and; a second jaw, wherein: the first jaw and the second jaw together define a containing groove configured to receive a fastener; the containing groove ends at a curved edge; the first jaw comprises a plurality of teeth extending into the containing groove; and the second jaw comprising a ridge extending into the containing groove.

The open-end wrench of any preceding clause, wherein upon receiving a new hexagonal fastener into the containing groove, the new hexagonal fastener sized to engage with the open end-wrench, the ridge prevents the new hexagonal fastener from going further into the containing groove.

The open-end wrench of any preceding clause, wherein upon receiving a rounded hexagonal fastener into the containing groove, the rounded hexagonal fastener sized to engage with the open end-wrench, applied torque allows the rounded hexagonal fastener to go further than the new hexagonal fastener into the containing groove, such that the rounded hexagonal fastener engages with the teeth and the ridge.

The open-end wrench of any preceding clause, wherein the teeth are set at a teeth angle offset from a centerline of the containing portion, the centerline extending through the containing groove at points equidistant between the first jaw and the second jaw.

The open-end wrench of any preceding clause, wherein the teeth angle is between 3° and 18° away from the centerline.

The open-end wrench of any preceding clause, wherein a height of the ridge is between 0.3 mm-1.5 mm.

The open-end wrench of any preceding clause, wherein a height of the ridge is based on a difference between a flat-edge diameter of a rounded hexagonal fastener sized to engage with the open end-wrench and a corner diameter of the rounded hexagonal fastener.

The open-end wrench of any preceding clause, wherein the height of the ridge is further determined by dividing the difference by two and multiplying by a factor.

The open-end wrench of claim 8, wherein the factor is 0.8.

An open-end wrench for torquing normal and rounded fasteners, comprising: a first jaw and; a second jaw, wherein: the first jaw and the second jaw together define a containing groove configured to receive a fastener; the containing groove ends at a curved edge; the first jaw comprises a plurality of teeth extending into the containing groove; and the second jaw comprising a ridge extending into the containing groove, wherein upon receiving a new hexagonal fastener into the containing groove, the new hexagonal fastener sized to engage with the open end-wrench, the ridge prevents the new hexagonal fastener from going further into the containing groove, and wherein upon receiving a rounded hexagonal fastener into the containing groove, the rounded hexagonal fastener sized to engage with the open end-wrench, applied torque allows the rounded hexagonal fastener to go further than the new hexagonal fastener into the containing groove, such that the rounded hexagonal fastener engages with the teeth and the ridge.

The open-end wrench of any preceding clause, wherein the teeth are set at a teeth angle offset from a centerline of the containing portion, the centerline extending through the containing groove at points equidistant between the first jaw and the second jaw.

The open-end wrench of any preceding clause, wherein the teeth angle is between 3° and 18° away from the centerline.

The open-end wrench of any preceding clause, wherein a height of the ridge is between 0.3 mm-1.5 mm.

The open-end wrench of any preceding clause, wherein a height of the ridge is based on a difference between a flat-edge diameter of a rounded hexagonal fastener sized to engage with the open end-wrench and a corner diameter of the rounded hexagonal fastener.

The open-end wrench of any preceding clause, wherein the height of the ridge is further determined by dividing the difference by two and multiplying by a factor.

The open-end wrench of any preceding clause, wherein the factor is 0.8.

An open-end wrench, comprising: a first jaw and; a second jaw, wherein: the first jaw and the second jaw together define a containing groove configured to receive a fastener; the first jaw comprises a plurality of teeth extending into the containing groove; and the second jaw comprising a ridge extending into the containing groove.

The open-end wrench of any preceding clause, wherein upon receiving a new hexagonal fastener into the containing groove, the new hexagonal fastener sized to engage with the open end-wrench, the ridge prevents the new hexagonal fastener from going further into the containing groove.

The open-end wrench of any preceding clause, wherein upon receiving a rounded hexagonal fastener into the containing groove, the rounded hexagonal fastener sized to engage with the open end-wrench, applied torque allows the rounded hexagonal fastener to go further than a new hexagonal fastener into the containing groove, such that the rounded hexagonal fastener engages with the teeth and the ridge.

The open-end wrench of any preceding clause, wherein the teeth are set at a teeth angle offset from a centerline of the containing groove, the centerline extending through the containing groove at points equidistant between the first jaw and the second jaw.

We claim:

1. An open-end wrench, comprising:
a handle portion; and
a containing portion, the containing portion comprising:
a first jaw and;
a second jaw,
wherein:
the first jaw and the second jaw together define a containing groove configured to receive a fastener;
the containing groove ends at a curved edge;
the first jaw comprises a plurality of teeth extending into the containing groove; and
the second jaw comprising a ridge extending into the containing groove.

2. The open-end wrench of claim 1, wherein upon receiving a new hexagonal fastener into the containing groove, the new hexagonal fastener sized to engage with the open end-wrench, the ridge prevents the new hexagonal fastener from going further into the containing groove.

3. The open-end wrench of claim 2, wherein upon receiving a rounded hexagonal fastener into the containing groove, the rounded hexagonal fastener sized to engage with the open end-wrench, applied torque allows the rounded hexagonal fastener to go further than the new hexagonal fastener into the containing groove, such that the rounded hexagonal fastener engages with the teeth and the ridge.

4. The open-end wrench of claim 1, wherein the teeth are set at a teeth angle offset from a centerline of the containing portion, the centerline extending through the containing groove at points equidistant between the first jaw and the second jaw.

5. The open-end wrench of claim 4, wherein the teeth angle is between 3° and 18° away from the centerline.

6. The open-end wrench of claim 1, wherein a height of the ridge is between 0.3 mm-1.5 mm.

7. The open-end wrench of claim 1, wherein a height of the ridge is based on a difference between a flat-edge diameter of a rounded hexagonal fastener sized to engage with the open end-wrench and a corner diameter of the rounded hexagonal fastener.

8. The open-end wrench of claim 7, wherein the height of the ridge is further determined by dividing the difference by two and multiplying by a factor.

9. The open-end wrench of claim 8, wherein the factor is 0.8.

10. An open-end wrench for torquing normal and rounded fasteners, comprising:
a first jaw and;
a second jaw,
wherein:
the first jaw and the second jaw together define a containing groove configured to receive a fastener;
the containing groove ends at a curved edge;
the first jaw comprises a plurality of teeth extending into the containing groove; and
the second jaw comprising a ridge extending into the containing groove, wherein upon receiving a new hexagonal fastener into the containing groove, the new hexagonal fastener sized to engage with the open end-wrench, the ridge prevents the new hexagonal fastener from going further into the containing groove, and
wherein upon receiving a rounded hexagonal fastener into the containing groove, the rounded hexagonal fastener sized to engage with the open end-wrench, applied torque allows the rounded hexagonal fastener to go further than the new hexagonal fastener into the containing groove, such that the rounded hexagonal fastener engages with the teeth and the ridge.

11. The open-end wrench of claim 10, wherein the teeth are set at a teeth angle offset from a centerline of the containing portion, the centerline extending through the containing groove at points equidistant between the first jaw and the second jaw.

12. The open-end wrench of claim 11, wherein the teeth angle is between 3° and 18° away from the centerline.

13. The open-end wrench of claim 10, wherein a height of the ridge is between 0.3 mm-1.5 mm.

14. The open-end wrench of claim 10, wherein a height of the ridge is based on a difference between a flat-edge diameter of a rounded hexagonal fastener sized to engage with the open end-wrench and a corner diameter of the rounded hexagonal fastener.

15. The open-end wrench of claim 14, wherein the height of the ridge is further determined by dividing the difference by two and multiplying by a factor.

16. The open-end wrench of claim 15, wherein the factor is 0.8.

17. An open-end wrench, comprising:
a first jaw and;
a second jaw,
wherein:
the first jaw and the second jaw together define a containing groove configured to receive a fastener;
the first jaw comprises a plurality of teeth extending into the containing groove; and
the second jaw comprising a ridge extending into the containing groove.

18. The open-end wrench of claim 17, wherein upon receiving a new hexagonal fastener into the containing groove, the new hexagonal fastener sized to engage with the open end-wrench, the ridge prevents the new hexagonal fastener from going further into the containing groove.

19. The open-end wrench of claim 17, wherein upon receiving a rounded hexagonal fastener into the containing groove, the rounded hexagonal fastener sized to engage with the open end-wrench, applied torque allows the rounded hexagonal fastener to go further than a new hexagonal fastener into the containing groove, such that the rounded hexagonal fastener engages with the teeth and the ridge.

20. The open-end wrench of claim 17, wherein the teeth are set at a teeth angle offset from a centerline of the containing groove, the centerline extending through the containing groove at points equidistant between the first jaw and the second jaw.
